(19) United States
(12) Patent Application Publication
(10) Pub. No.: US 2005/0112538 A1
(43) Pub. Date: May 26, 2005

(54) Talking floor mat learning tool

(76) Inventor: Armada Christina Pinkins, Tulsa, OK (US)

Correspondence Address: Dr. Armada C. Pinkins, P.O. Box 702341, Tulsa, OK, 74170, US

(21) Appl. No.: 10/720,884

(22) Filed: Nov. 25, 2003

(51) Int. Cl. G09B 7/00

(52) U.S. Cl. 434/322

(57) ABSTRACT

A Talking Floor Mat Learning Tool that can be used to teach young children content such as, colors, shapes, numbers, simple math, phonemes, phonics, etc. while affording the learner the opportunity to move and respond by placing his/her foot on the floor mat. More specifically, the Talking Floor Mat Learning Tool has content modules which are connected to a battery powered audio box which asks questions, gives responses to answers, gives directions and even gives praises to the learners.

### CROSS-REFERENCE TO RELATED APPLICATIONS

Not Applicable

### BACKGROUND OF THE INVENTION

1. Field of the Invention

This invention relates to talking floor mats as a learning tool.

2. Description of Related Art

In simplest form, the talking floor mat learning tool is an electronic learning game consisting of two plastic pieces of material of various shapes and sizes with a thin inner foam sewn together. An audio box is attached to the material and is centrally mounted at the very top area of the mat. The audio box is powered by batteries and connected to response items on the mat by a thin electrical wire. The audio box is equipped with recorded messages to ask questions, give responses to answers, and directions. In addition, the audio box is equipped with a timing mechanism to keep track of the response time and to respond if the answers are not given within the allowed time.

### BRIEF SUMMARY OF THE INVENTION

It is an object of the invention to provide a learning tool that is fun and interactive. Research indicates that children have different learning styles and kinesthetic learners who need to move and utilize major muscle groups to facilitate their learning are inadequately addressed with many of the learning resources. This invention provides a learning tool to address directives in the “No Child Left Behind Act.” According to the invention, there is provided an audio box, which asks content related questions on the subject to be learned. The learner responds by stepping on the correct answer on the mat. The message from the audio box will respond with another question if the correct answer is given but will respond with the same question if an incorrect response is given. Should the learner give two incorrect responses, the audio box will give the correct answer. There are at least two skill levels. The advantage of the invention is providing an effective learning tool that can be used with young learners for many different subjects to facilitate the acquisition of knowledge. This tool can also be used to facilitate second language acquisition.

### BRIEF DESCRIPTION OF AERIAL VIEW OF THE DRAWING

The Talking Floor Mat Learning Tool will now be described by way of example with reference to accompanying drawing:

FIG. 1 is an aerial view of the Talking Floor Mat Learning Tool.

FIG. 2 is an internal view of the Talking Floor Mat Learning Tool with outer cover removed to reveal internal connections.

### DETAILED DESCRIPTION OF THE INVENTION

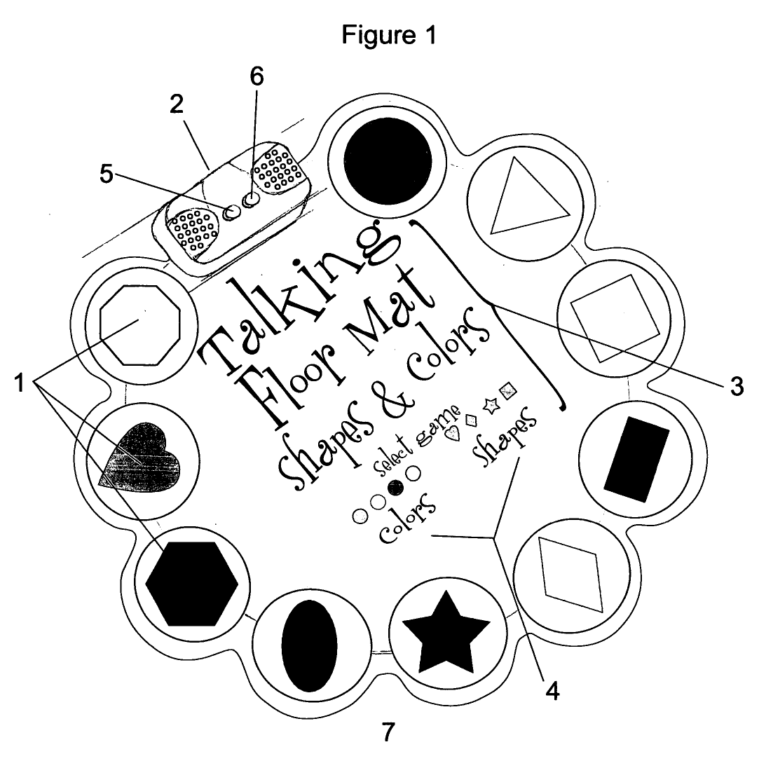

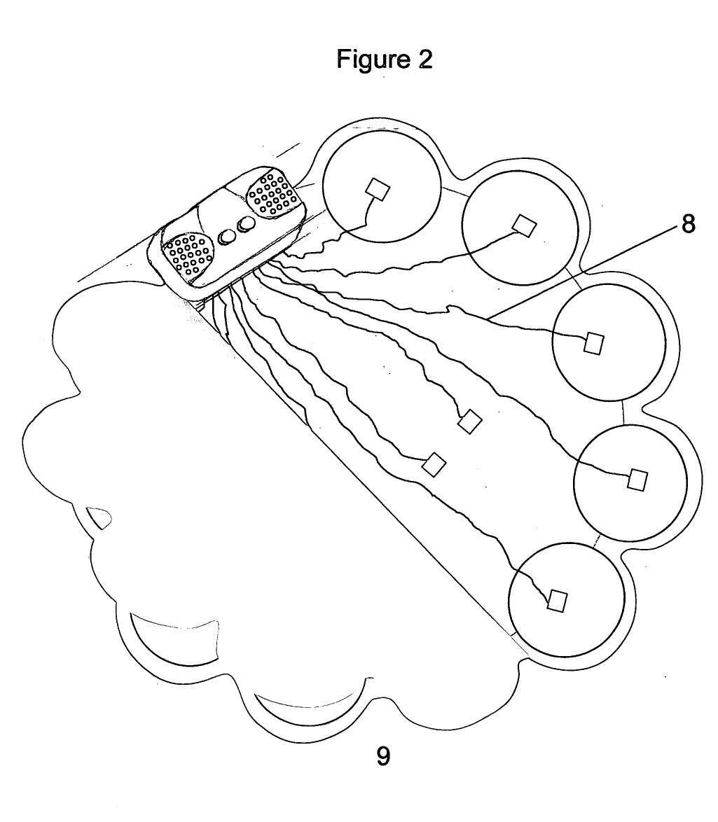

An exemplary learning tool called the Talking Floor Mat Learning Tool 7 is shown in FIG. 1. and designated in general by the reference character 7. As shown, the Talking Floor Mat Learning Tool 7 includes ten content modules 1 connected to an audio box 2 by a thin electrical wire 8 as shown in FIG. 2 reference character 9 and FIG. 1 reference character 7, an instructional area 3 with game selection options 4. The audio box 2 has an on/off switch 5 and a level switch 6. In addition, the audio box 2 contains a battery pack, timing mechanism and has pre-recorded messages to ask questions, give responses to questions, and give directions. The child selects a game by placing his foot on the game selection option 4 which sends a signal to the audio box 2, which then starts the timer and begins verbal questions. The child responds to the questions by placing his foot on the module 1 of the answer he thinks is correct and that will send a signal to the audio box. If the answer is correct, the audio box 2 lets the learner know that he is correct and then proceeds to the next question. If the response is an incorrect answer, the audio box 2 gives the learner another chance. If two incorrect responses are given the audio box 2 will give the learner the correct answer. At the conclusion of the game, the audio box 2 gives the learner the total and also gives a positive message.

1. A Talking Floor Mat learning Tool with prerecorded messages.

2. Said floor mat in claim 1 combining an audio box with prerecorded messages.

3. Said audio box in claim 2 combining a battery pack.
